(19) United States
(12) Patent Application Publication
(10) Pub. No.: US 2025/0148820 A1
(43) Pub. Date: May 8, 2025

(54) CHARACTER RECOGNITION DEVICE, CHARACTER RECOGNITION METHOD, AND PROGRAM

(71) Applicants: Kabushiki Kaisha Toshiba, Tokyo (JP); Toshiba Digital Solutions Corporation, Kawasaki-shi (JP)

(72) Inventor: Ryohei TANAKA, Kawasaki (JP)

(73) Assignees: Kabushiki Kaisha Toshiba, Tokyo (JP); Toshiba Digital Solutions Corporation, Kawasaki-shi (JP)

(21) Appl. No.: 19/014,383

(22) Filed: Jan. 9, 2025

Related U.S. Application Data
(63) Continuation of application No. PCT/JP2022/027500, filed on Jul. 13, 2022.

(51) Int. Cl. G06V 30/19; G06V 30/146

(52) U.S. Cl. CPC G06V 30/1912; G06V 30/147

(57) ABSTRACT

A character recognition device of an embodiment includes a first score calculation unit, a character region estimation unit, a second score calculation unit, and a selection unit. The first score calculation unit calculates a first score indicating a likelihood of a character string, or the first score for each of a plurality of candidate character strings which are candidates for character strings included in an input image. The character region estimation unit estimates a region corresponding to each character included in the candidate character string among regions of the input image. The second score calculation unit calculates a second score indicating a consistency of characters included in the candidate character string on the basis of the estimated region. The selection unit selects one or more character strings from among the plurality of candidate character strings on the basis of the calculated first score and the calculated second score.

### TECHNICAL FIELD

An embodiment of the present invention relates to a character recognition device, a character recognition method, and a program.

### BACKGROUND ART

Since the past, a character recognition technique of recognizing characters included in an input image has been known. According to such a prior art, it is known that the accuracy of recognition can be improved by recognizing characters without explicitly dividing the boundaries between the characters. However, in a case where characters are recognized without dividing the boundaries between the characters, one character may be recognized overlappingly. In addition, depending on the input image, some characters may be skipped over during recognition. That is, according to the prior art, there is a problem in that characters included in the input image cannot be correctly recognized.

### CITATION LIST

### Patent Document

Patent Document 1: Japanese Unexamined Patent Application, First Publication No. 2013-097590

### SUMMARY OF INVENTION

### Technical Problem

A problem to be solved by the present invention is to provide a character recognition device, a character recognition method, and a program that make it possible to correctly recognize characters included in an input image.

### Solution to Problem

A character recognition device of an embodiment includes a first score calculation unit, a character region estimation unit, a second score calculation unit, and a selection unit. The first score calculation unit calculates a first score indicating a likelihood of a character string, or the first score for each of a plurality of candidate character strings which are candidates for character strings included in an input image. The character region estimation unit estimates a region corresponding to each character included in the candidate character string among regions of the input image. The second score calculation unit calculates a second score indicating a consistency of characters included in the candidate character string on the basis of the estimated region. The selection unit selects one or more character strings from among the plurality of candidate character strings on the basis of the calculated first score and the calculated second score.

### BRIEF DESCRIPTION OF DRAWINGS

FIG. 1 A schematic diagram illustrating an example of a functional configuration of a character recognition system according to a first embodiment.

FIG. 2 A diagram illustrating an example of an input image according to the first embodiment.

FIG. 3 A diagram illustrating a first score according to the first embodiment.

FIG. 4 A diagram illustrating a second score according to the first embodiment.

FIG. 5 A flowchart illustrating a series of operations of the character recognition system according to the first embodiment.

FIG. 6 A diagram illustrating a modification example of a functional configuration of a second score calculation unit according to the first embodiment.

FIG. 7 A diagram illustrating overlapping reading according to the first embodiment.

FIG. 8 A diagram illustrating an example of a functional configuration of a skipping score calculation unit according to the first embodiment.

FIG. 9 A diagram illustrating a character-likeliness map according to the first embodiment.

FIG. 10 A diagram illustrating a modification example of a functional configuration of a first score calculation unit according to the first embodiment.

FIG. 11 A diagram illustrating a beam search according to a second embodiment.

FIG. 12 A diagram illustrating a consistency score for each partial input image in the beam search according to the second embodiment.

FIG. 13 A flowchart illustrating a series of operations of a character recognition system according to the second embodiment.

FIG. 14 A diagram illustrating an example of an input image according to a third embodiment.

FIG. 15 A diagram illustrating an example of a second score according to the third embodiment.

FIG. 16 A diagram illustrating an example of an operation of a character region estimation unit according to a fourth embodiment.

FIG. 17 A diagram illustrating a modification example of an operation of the character region estimation unit according to the fourth embodiment.

FIG. 18 A diagram illustrating a modification example of a character-likeliness map according to a fifth embodiment.

FIG. 19 A diagram illustrating an example of a functional configuration of a modification example of a character-likeliness map generation unit according to the fifth embodiment.

FIG. 20 A diagram illustrating an example of input data and training data according to the fifth embodiment.

FIG. 21 A diagram illustrating overlapping reading and skipping according to the prior art.

### DESCRIPTION OF EMBODIMENTS

Hereinafter, a character recognition device, a character recognition method, and a program of an embodiment will be described with reference to the accompanying drawings.

### PRIOR ART

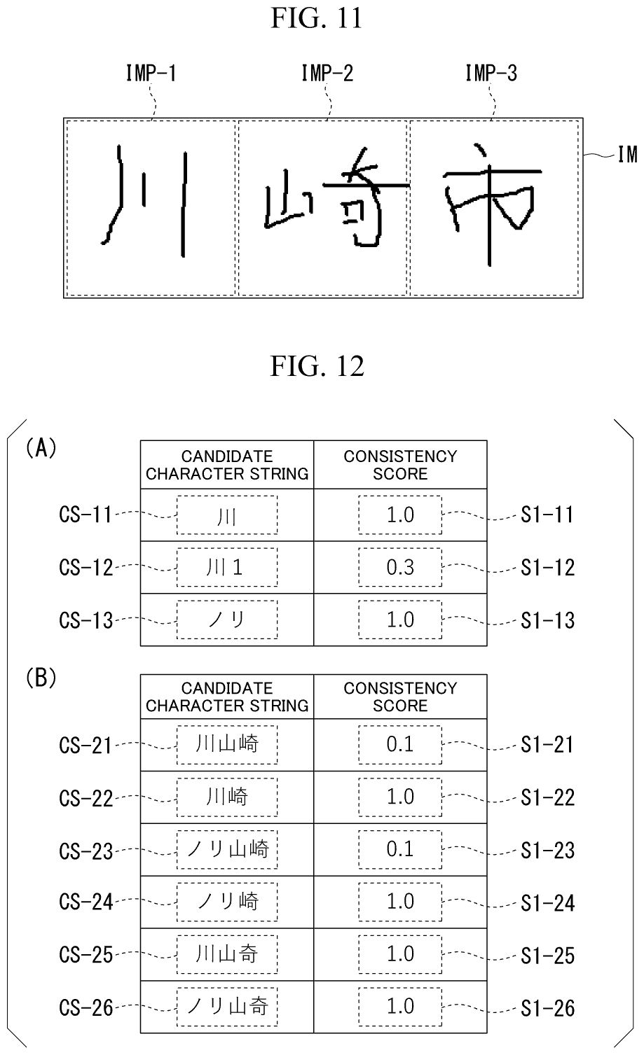

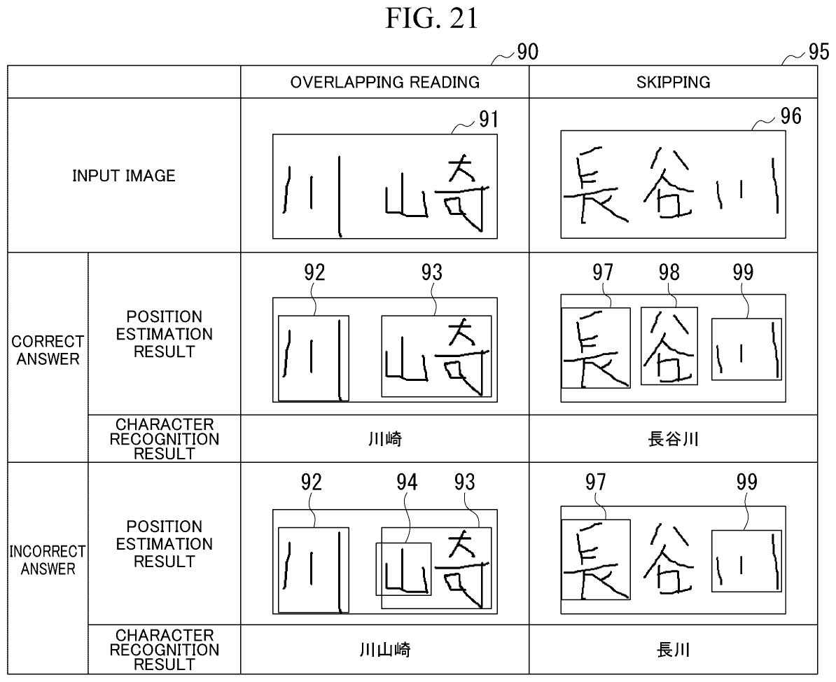

Problems that arise in a case where a character recognition method according to the prior art is used will be described with reference to FIG. 21. FIG. 11 is a diagram illustrating overlapping reading and skipping according to the prior art. Column 90 shows an example of overlapping reading, and column 95 shows an example of skipping.

As an example of overlapping reading, a case in which an input image 91 is input will be described. In a case where correct character recognition is performed on a character string written in the input image 91, a region 92 and a region 93 are estimated as positions at which characters are written. Since “ [symbol] ” is written in the region 92 and “ [symbol] ” is written in the region 93, a character recognition method according to the prior art makes it possible to recognize that “ [symbol] ” is written in the input image 91. On the other hand, in a case where the character string written in the input image 91 is erroneously recognized as characters, the region 92, the region 93, and a region 94 are estimated as positions at which the characters are written. Since “ [symbol] ” is written in the region 92, “ [symbol] ” is written in the region 93, and “ [symbol] ” is written in the region 94, the character recognition method according to the prior art results in erroneous recognition that “ [symbol] ” is written the input image 91. In this way, in an example of overlapping reading, the left-hand side of “ [symbol] ” is recognized as “ [symbol] ” and then “ [symbol] ” is recognized again, resulting in the problem of the character “ [symbol] ” being recognized overlappingly.

Next, in an example of skipping, a case in which an input image 96 is input will be described. In a case where correct character recognition is performed on a character string written in the input image 96, a region 97, a region 98, and a region 99 are estimated as positions at which characters are written. Since “ [symbol] ” is written in the region 97, “ [symbol] ” is written in the region 98, and “ [symbol] ” is written in the region 99, the character recognition method according to the prior art makes it possible to recognize that “ [symbol] ” is written in the input image 96. On the other hand, in a case where the character string written in the input image 96 is erroneously recognized as characters, the region 97 and the region 98 are estimated as positions at which the characters are written. Since “ [symbol] ” is written in the region 97 and “ [symbol] ” is written in the region 99, the character recognition method according to the prior art results in erroneous recognition that “ [symbol] ” is written in the input image 96. In this way, in an example of skipping, there is a problem in that the character “ [symbol] ” written in the region 98 is skipped over in recognition.

### First Embodiment

The character recognition device according to the present embodiment overcomes the problems caused by the prior art as described above. The character recognition device according to the present embodiment performs character string recognition on a character string written in an input image. The character string recognition is a task of recognizing a character string in an image using an image including the character string as an input. In the present embodiment, a horizontally written character string which is read from left to right will be described. Meanwhile, in the present embodiment, there is no limitation to a horizontally written character string which is read from left to right, and the same applies to a vertically written character string. Meanwhile, the image including a character string broadly includes an image of handwritten characters, a photographed signboard, a road sign, and the like. Meanwhile, in the present embodiment, a case in which the number of characters included in a character string is equal to or greater than 0 will be described.

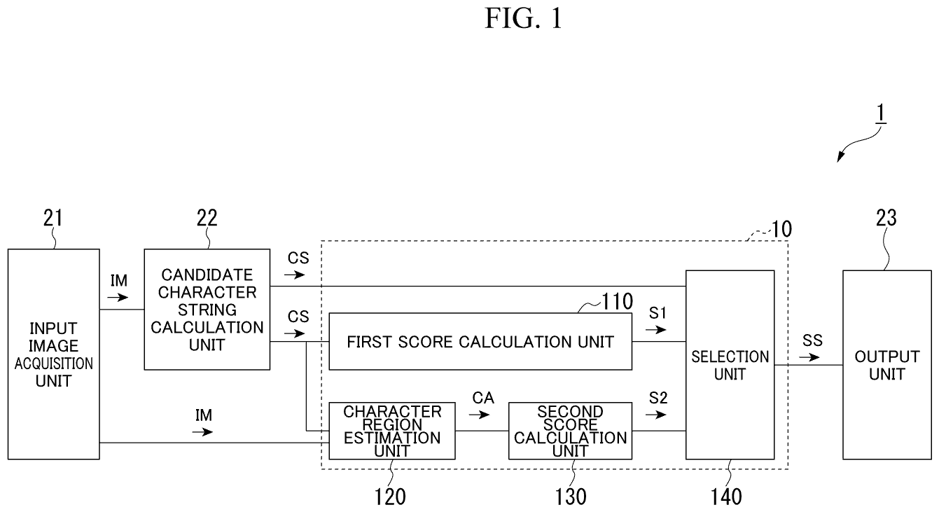

FIG. 1 is a schematic diagram illustrating an example of a functional configuration of a character recognition system according to a first embodiment. The functional configuration of a character recognition system 1 will be described with reference to the drawing. The character recognition system 1 includes an input image acquisition unit 21, a candidate character string calculation unit 22, a character recognition device 10, and an output unit 23.

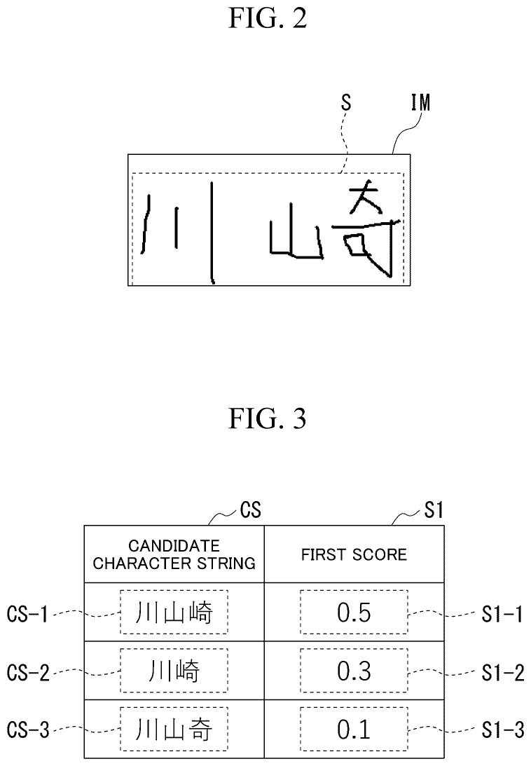

The input image acquisition unit 21 acquires an input image IM. FIG. 2 is a diagram illustrating an example of the input image IM according to the first embodiment. A character string S is written in the input image IM. Specifically, the character string S which is the handwritten character “ [symbol] ” is written in the input image IM. In the present embodiment, an example of a case in which the handwritten character string S is written in the input image IM will be described.

Referring back to FIG. 1, the candidate character string calculation unit 22 calculates a candidate character string CS which is a candidate for the character string S written in the input image IM acquired by the input image acquisition unit 21. The candidate character string calculation unit 22 calculates the candidate character string CS using a known character recognition technique (such as, for example, pattern matching or feature detection). The candidate character string calculation unit 22 outputs a plurality of characters strings S as the candidate character strings CS.

The character recognition device 10 selects a plausible character string from among a plurality of candidate character strings CS calculated by the candidate character string calculation unit 22 as the selection character string SS on the basis of the input image IM acquired by the input image acquisition unit 21 and the plurality of candidate character strings CS calculated by the candidate character string calculation unit 22. The character recognition device 10 includes a first score calculation unit (character recognition unit) 110, a character region estimation unit 120, a second score calculation unit (region consistency score calculation unit) 130, and a selection unit 140.

The output unit 23 outputs the selection character string SS selected by the character recognition device 10. The output unit 23 outputs the selection character string SS, for example, by outputting information for displaying the selection character string SS on a display unit (not shown), outputting information for performing audio output from an audio output unit (not shown), or performing wireless output to an information processing device (not shown).

The first score calculation unit 110 calculates a first score S1 for each of the plurality of candidate character strings CS calculated by the candidate character string calculation unit 22. The candidate character string CS is a candidate for the character string S included in the input image IM. The first score S1 indicates the likelihood of a character string. That is, the first score calculation unit 110 calculates the first score S1 indicating the likelihood of a character string, or the first score S1 for each of the plurality of candidate character strings CS which are candidates for the character string S included in the input image IM.

FIG. 3 is a diagram illustrating a first score according to the first embodiment. A specific example of the first score S1 calculated by the first score calculation unit 110 will be described with reference to the drawing. The drawing shows an example of a case in which the character string “ [symbol] ” is included in the input image IM. In this example, the candidate character string calculation unit 22 calculates “ [symbol] ” as a candidate character string CS-1, “ [symbol] ” as a candidate character string CS-2, and “ [symbol] ” as a candidate character string CS-3. The first score calculation unit 110 calculates the first score S1 for each of the candidate character string CS-1, the candidate character string CS-2, and the candidate character string CS-3. In this example, a first score S1-1 of the candidate character string CS-1 is “0.5,” a first score S1-2 of the candidate character string CS-2 is “0.5,” and a first score S1-3 of the candidate character string CS-3 is “0.1.”

Referring back to FIG. 1, the character region estimation unit 120 estimates a character region CA on the basis of the candidate character string CS and the input image IM. The character region CA is a region corresponding to each character C included in the candidate character string CS. That is, the character region estimation unit 120 estimates the character region CA which is a region corresponding to each character C included in the candidate character string CS in the region of the input image IM.

The second score calculation unit 130 calculates a second score S2 indicating the consistency of characters included in the candidate character string CS on the basis of the character region CA which is a region estimated by the character region estimation unit 120. Here, the consistency of characters included in the candidate character string CS refers to spatial consistency. In a case where there is no spatial consistency, characters may overlap each other or characters may be skipped.

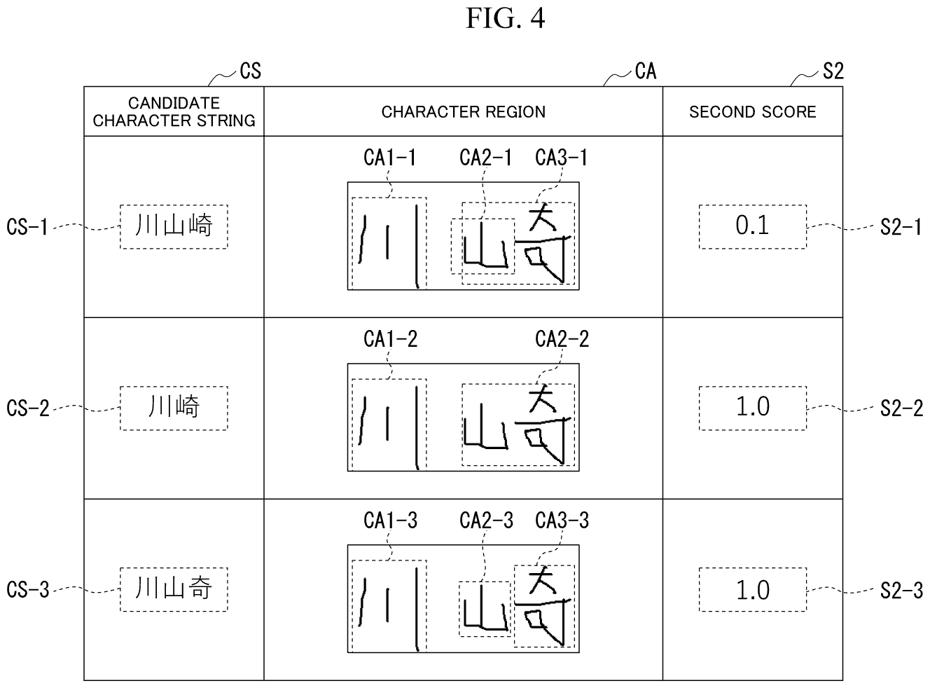

FIG. 4 is a diagram illustrating a second score according to the first embodiment. Reference will be made to the drawing to describe the estimation of the character region CA performed by the character region estimation unit 120 and a specific example of the second score S2 calculated by the second score calculation unit 130. The drawing shows an example in which the character string “ [symbol] ” is included in the input image IM. In this example, the character region estimation unit 120 estimates the character region CA which is a region corresponding to each character C included in the candidate character string CS. For example, the character region estimation unit 120 estimates regions corresponding to the character C included in “ [symbol] ” which is the candidate character string CS-1 as a character region CA1-1, a character region CA2-1, and a character region CA3-1. In addition, the character region estimation unit 120 estimates regions corresponding to the character C included in “ [symbol] ” which is the candidate character string CS-2 as a character region CA1-2 and a character region CA2-2. In addition, the character region estimation unit 120 estimates regions corresponding to the character C included in “ [symbol] ” which is the candidate character string CS-3 as a character region CA1-3, a character region CA2-3, and a character region CA3-3.

The second score calculation unit 130 calculates the second score S2 for each of the plurality of candidate character strings CS. In this example, a second score S2-1 of the candidate character string CS-1 is “0.1,” a second score S2-2 of the candidate character string CS-2 is “1.0,” and a second score S2-3 of the candidate character string CS-3 is “1.0.”

Referring back to FIG. 1, the selection unit 140 selects one or more character strings S from among the plurality of candidate character strings CS as the selection character string SS on the basis of the calculated first score S1 and second score S2. For example, the selection unit 140 selects the candidate character string CS having the largest value as the selection character string SS as a result of multiplying the first score S1 and the second score S2.

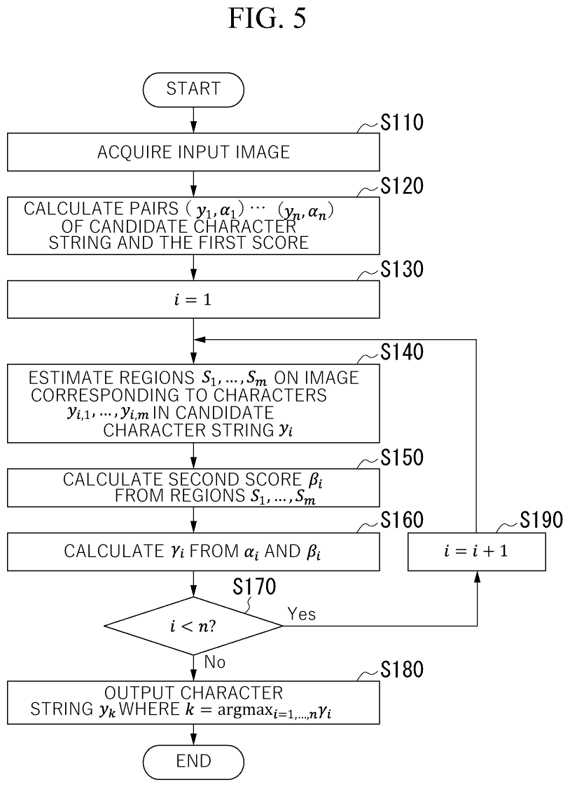

FIG. 5 is a flowchart illustrating a series of operations of the character recognition system according to the first embodiment. Hereinafter, a series of operations of the character recognition device 10 will be described with reference to the flowchart shown in the drawing.

(Step S110) The input image acquisition unit 21 acquires the input image IM. The candidate character string calculation unit 22 calculates the candidate character string CS which is a candidate for the character string S written in the input image IM. In this flowchart, a case in which the candidate character string calculation unit 22 calculates n (n is integer equal to or greater than 1) candidate character strings CS will be described.

(Step S120) The first score calculation unit 110 calculates the first score S1 for each of the candidate character strings CS among the calculated plurality of candidate character strings CS. That is, in a case where the candidate character string CS is yₙ and the first score S1 is αₙ, the first score calculation unit 110 calculates (y₁, α₁) . . . (yₙ, αₙ).

(Step S130) The second score calculation unit 130 sets a counter i to 1.

(Step S140) The character region estimation unit 120 estimates a region of the input image IM that corresponds to each of a plurality of characters C included in the candidate character string CS. In this flowchart, a case in which m characters are included in the candidate character string CS (m is an integer equal to or greater than 1) will be described. That is, characters C of y_{i, 1}, . . . , y_{i, m} are included in yᵢ which is the candidate character string CS. In this case, the character region estimation unit 120 estimates s₁, . . . , sₘ which are the character region CA corresponding to each character C.

(Step S150) The second score calculation unit 130 calculates the second score S2 for yᵢ which is the candidate character string CS. The second score S2 is also referred to as βₙ. In addition, βₙ which is the second score S2 is calculated on the basis of s₁, . . . , sₘ.

(Step S160) The selection unit 140 calculates yᵢ on the basis of αᵢ which is the first score S1 and βᵢ which is the second score S2.

(Step S170) In the case of i<n, the second score calculation unit 130 advances the process to step S190. That is, the second score calculation unit 130 repeats steps from step S140 to step S160 until the counter i reaches n which is the number of candidate character strings CS calculated by the candidate character string calculation unit 22. In the case of not being i<n, that is, in a case where the counter i has reached n which is the number of candidate character strings CS calculated by the candidate character string calculation unit 22, the second score calculation unit 130 advances the process to step S180.

(Step S190) The second score calculation unit 130 increments the counter i, and advances the process to step S140.

(Step S180) The selection unit 140 selects the candidate character string CS in which γₙ becomes maximum as the selection character string SS. In this flowchart, the selection unit 140 selects the selection character string SS based on the maximum point set. Meanwhile, the selection unit 140 may select the selection character string SS based on the minimum point set in accordance with a method of calculating αₙ and βₙ.

### Modification Example of First Embodiment

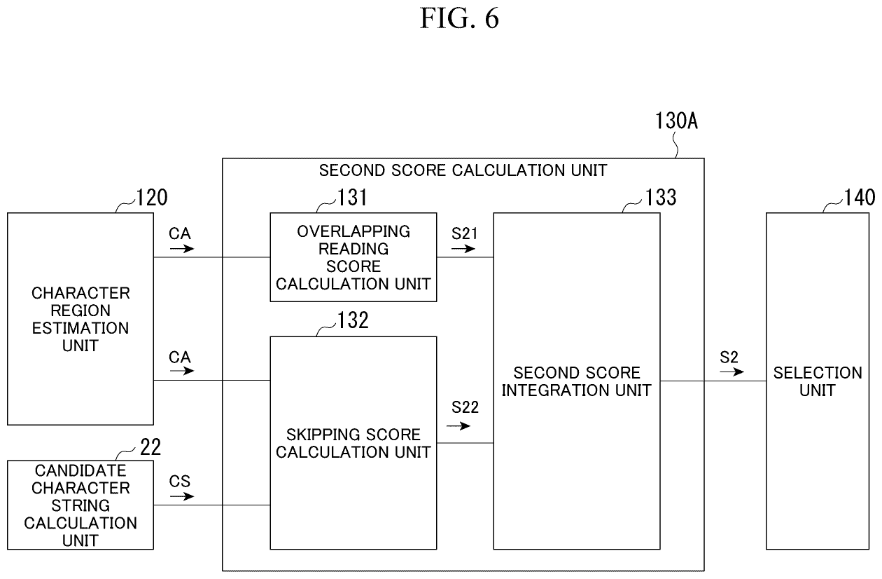

FIG. 6 is a diagram illustrating a modification example of a functional configuration of a second score calculation unit according to the first embodiment. A second score calculation unit 130A which is a modification example of the second score calculation unit 130 will be described with reference to the drawing. The second score calculation unit 130A includes an overlapping reading score calculation unit 131, a skipping score calculation unit 132, and a second score integration unit 133.

The overlapping reading score calculation unit 131 calculates an overlapping reading score S21 which is a score indicating the amount of overlapping of the candidate character string CS. The amount of overlapping of the candidate character string CS is specifically an amount by which regions corresponding to the characters C included in the candidate character string CS overlap each other. The second score calculation unit 130A calculates the second score S2 on the basis of the calculated overlapping reading score S21. That is, in the present embodiment, the second score calculation unit 130A calculates the second score S2 on the basis of an amount by which regions corresponding to the characters C included in the candidate character string CS overlap each other.

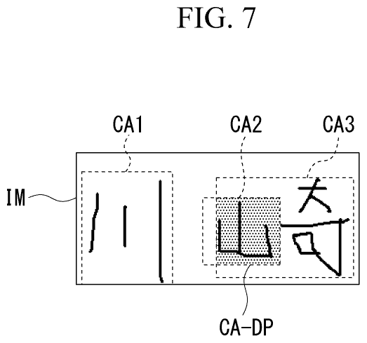

FIG. 7 is a diagram illustrating overlapping reading according to the first embodiment. The amount of overlapping calculated by the overlapping reading score calculation unit 131 will be described with reference to the drawing. In this example, the character “ [symbol] ” is written in the input image IM, and the character region estimation unit 120 estimates a character region CA1, a character region CA2, and a character region CA3 as the character region CA. Here, an overlapping region CA-DP which is a region where the character region CA2 and the character region CA3 overlap each other is the amount of overlapping. Specifically, in a case where the amount of overlapping is m(y), the overlapping reading score calculation unit 131 calculates the following Expression (1) as an overlapping consistency score Pₒᵥₗₚ.

$$\begin{matrix}[ Equation 1 ] & \\ {P}_{ovlp} ( y ) := {( {C}_{OP} )}^{m ( y )} & ( 1 )\end{matrix}$$

Here, C_{OP} is a constant between 0 and 1, and as this value decreases, the overlapping consistency score Pₒᵥₗₚ becomes small. The value of Cop may be obtained experimentally.

Referring back to FIG. 6, the skipping score calculation unit 132 calculates a skipping score S22 which is a score indicating whether skipping has occurred on the basis of the character C included in the candidate character string CS and the region estimated by the character region estimation unit 120. The second score calculation unit 130 calculates the second score S2 on the basis of the calculated skipping score S22. That is, the second score calculation unit 130 calculates the second score S2 on the basis of the character C included in the candidate character string CS and the region estimated by the character region estimation unit 120.

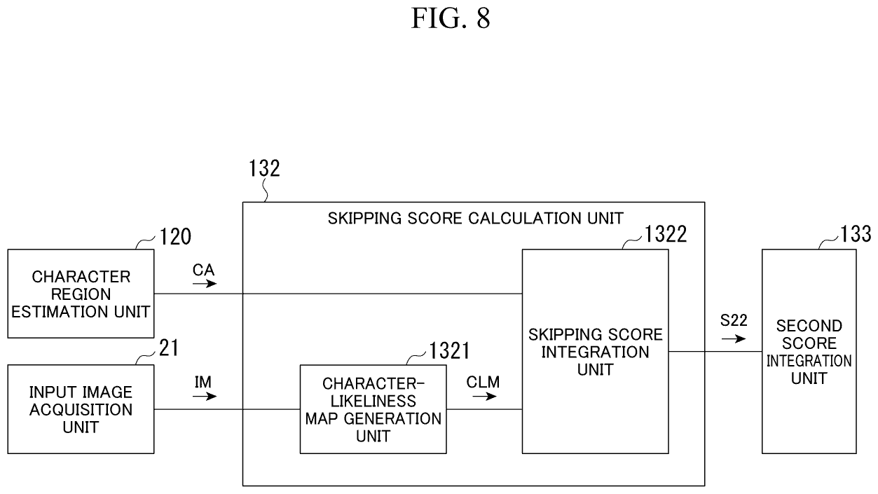

FIG. 8 is a diagram illustrating an example of a functional configuration of a skipping score calculation unit according to the first embodiment. An example of the functional configuration of the skipping score calculation unit 132 will be described with reference to the drawing. The skipping score calculation unit 132 includes a character-likeliness map generation unit 1321 and a skipping score integration unit 1322. In the present embodiment, the skipping score calculation unit 132 calculates the second score S2 on the basis of the likelihood that some character C exists in the region of the input image IM.

The character-likeliness map generation unit 1321 generates a character-likeliness map CLM. The character-likeliness map CLM indicates the likelihood that some character C exists in the image region of the input image IM.

The skipping score integration unit 1322 calculates the skipping score S22 on the basis of the character region CA estimated by the character region estimation unit 120 and the character-likeliness map CLM generated by the character-likeliness map generation unit 1321.

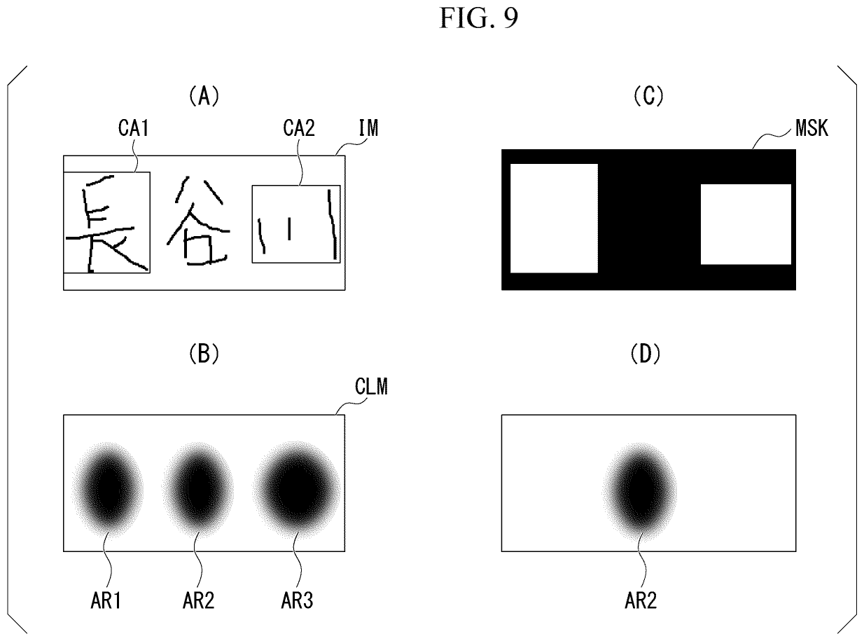

FIG. 9 is a diagram illustrating a character-likeliness map according to the first embodiment. An overview of the character-likeliness map CLM and the process performed by the skipping score integration unit 1322 will be described with reference to the drawing.

FIG. 9(A) is a diagram illustrating a character region CA in a case where the character region estimation unit 120 estimates the character region CA for a candidate character string CS that has undergone erroneous recognition of skipping. In the drawing, the character “ [symbol] ” in “ [symbol] ” which is the character string S included in the input image IM is estimated as the character region CA1, and the character “ [symbol] ” is estimated as the character region CA2. The character “ [symbol] ” is not estimated as the character region CA. That is, skipping has occurred.

FIG. 9(B) is a diagram illustrating an example of the character-likeliness map CLM. In an example shown in the drawing, there is a high probability that characters exist in a region AR1, a region AR2, and a region AR3. That is, the character-likeliness map generation unit 1321 estimates the likelihood that the character C exists for the character string S including characters that have been skipped in order to generate the likelihood that some character C exists in the image region of the input image IM as the character-likeliness map CLM.

FIG. 9(C) is a diagram illustrating an example of a mask MSK. The skipping score integration unit 1322 generates the mask MSK on the basis of the character region CA estimated by the character region estimation unit 120. The mask MSK indicates a region where characters included in the candidate character string CS exist or do not exist. The skipping score integration unit 1322 filters the character-likeliness map CLM using the generated mask MSK. The skipping score integration unit 1322 filters the character-likeliness map CLM to estimate a region having a high probability that a character exists regardless of the character not being included in the candidate character string CS.

FIG. 9(D) is a diagram illustrating the character-likeliness map CLM after being filtered by the skipping score integration unit 1322. The region AR2 is a region where there is a high probability that a character exists but it is not included in the candidate character string CS. That is, it can be said, as the region AR2 becomes large, there is a higher probability that skipping has occurred.

Here, a region where there is a high probability that some character C exists in the image region of the input image IM and it is included in the character-likeliness map CLM after being filtered is denoted by Uⱼ(y). In a case where the image region of the input image IM is divided into a width W and a height H, the skipping score integration unit 1322 calculates the following Expression (2) as a skipping consistency score P_{SKIP}(y). Meanwhile, the image region of the input image IM may be divided into pixel units of the input image IM, or may be divided into units of a predetermined range constituted by a plurality of pixels.

$$\begin{matrix}[ Equation 2 ] & \\ {P}_{SKIP} ( y ) := {\prod }_{j = 1 , ... , WH} {( 1 - {U}_{j} ( y ) )}^{{C}_{sp}} & ( 2 )\end{matrix}$$

Here, C_{SP} is a constant equal to or greater than 0, and as C_{SP} becomes large, the skipping consistency score P_{SKIP} decreases. The value of C_{SP} may be obtained experimentally. Meanwhile, in a case where no skipping penalty is imposed, C_{SP} may be set to 0.

Referring back to FIG. 6, the second score integration unit 133 calculates the second score S2 on the basis of the overlapping reading score S21 calculated by the overlapping reading score calculation unit 131 and the skipping score S22 calculated by the skipping score calculation unit 132. For example, the second score integration unit 133 calculates a value obtained by multiplying the overlapping reading score S21 and the skipping score S22 as the second score S2.

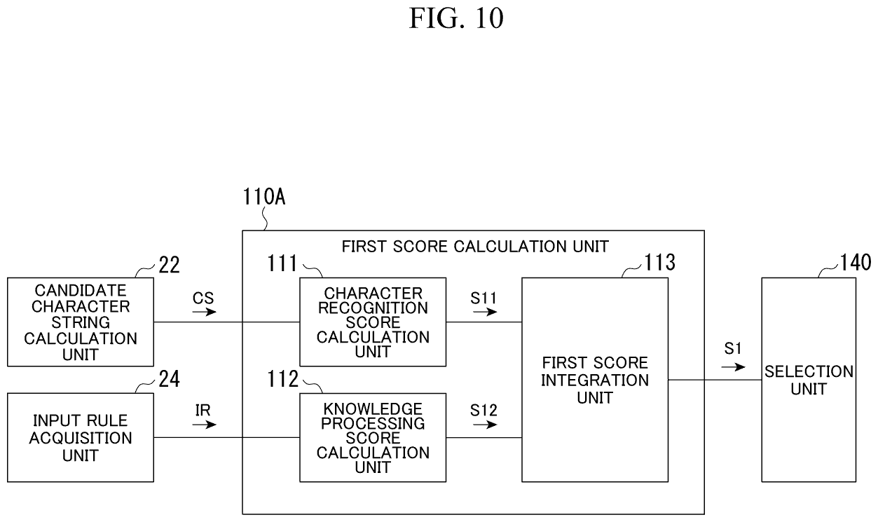

FIG. 10 is a diagram illustrating a modification example of a functional configuration of a first score calculation unit according to the first embodiment. A first score calculation unit 110A which is a modification example of the first score calculation unit 110 will be described with reference to the drawing. The first score calculation unit 110A includes a character recognition score calculation unit 111, a knowledge processing score calculation unit 112, and a first score integration unit 113.

The character recognition score calculation unit 111 calculates a character recognition score S11 for each candidate character string CS. The character recognition score S11 indicates the likelihood of a character string.

The knowledge processing score calculation unit 112 calculates a knowledge processing score S12 for each candidate character string CS. The knowledge processing score calculation unit 112 is used in a case where the number of candidate character strings CS to be written in the input image IM is limited. The case where the number of candidate character strings CS to written in the input image IM is limited is, for example, a case where information that the input image IM is a zip code, an address, a name, and the like is obtained in advance. In a case where it is known that the input image IM is a zip code, and a case where the candidate character string CS is not a numeral, the knowledge processing score S12 is calculated to be low. In addition, in a case where it is known that the input image IM is an address, the knowledge processing score S12 is calculated to be low for “ [symbol] ” than for “ [symbol] .”

The first score integration unit 113 calculates the first score S1 on the basis of the character recognition score S11 calculated by the character recognition score calculation unit 111 and the knowledge processing score S12 calculated by the knowledge processing score calculation unit 112. The selection unit 140 selects the selection character string SS on the basis of the calculated first score S1 and second score S2.

Here, an example in which the selection unit 140 selects the selection character string SS on the basis of the character recognition score S11, the knowledge processing score S12, the overlapping reading score S21, and the skipping score S22 will be described. In this case, the selection unit 140 selects the selection character string SS on the basis of the following Expression (3).

$$\begin{matrix}[ Equation 3 ] & \\ \hat{y} = arg {max}_{y} {P}_{OCR} ( y ) {P}_{LM} ( y ) {P}_{ovlp} ( y ) {P}_{skip} ( y ) & ( 3 )\end{matrix}$$

Specifically, the selection unit 140 selects, as the selection character string SS, the candidate character string CS that has the maximum value obtained by multiplying P_{OCR} which is the character recognition score S11, PLM which is the knowledge processing score S12, Pₒᵥₗₚ which is the overlapping reading score S21, and Pₛₖᵢₚ which is the skipping score S22.

### Summary of First Embodiment

According to the above-described embodiment, the character recognition device 10 includes the first score calculation unit 110 to calculate the first score S1 indicating the likelihood of the character string S for each candidate character string CS, includes the character region estimation unit 120 to estimate a region for each character C included in the character string S, includes the second score calculation unit 130 to calculate the second score S2 indicating the consistency of the character C, and includes the selection unit 140 to select the selection character string SS on the basis of the first score S1 and the second score S2. That is, according to the above-described embodiment, the maximum likelihood character string is selected in consideration of the consistency of the region where the character C exists. Therefore, the character recognition device 10 can correctly recognize the character C included in the input image IM.

In addition, according to the above-described embodiment, the second score calculation unit 130 calculates the second score S2 on the basis of the overlapping reading score S21. The overlapping reading score S21 is a score according to an amount by which regions corresponding to the characters C included in the candidate character string CS overlap each other. Therefore, according to the present embodiment, the character recognition device 10 can prevent overlapping reading, and can therefore correctly recognize the character C included in the input image IM.

In addition, according to the above-described embodiment, the second score calculation unit 130 calculates the second score S2 on the basis of the skipping score S22. The skipping score S22 is a score based on the character C included in the candidate character string CS and the character region CA estimated by the character region estimation unit 120, and in a case where skipping has occurred, a larger penalty given. Therefore, according to the present embodiment, the character recognition device 10 can prevent skipping, and can therefore correctly recognize the character C included in the input image IM.

Here, according to the prior art, there is a trade-off between the improvement of overlapping reading and the improvement of skipping, improving one of them makes the other problem more likely to occur. According to the above-described embodiment, the overlapping reading score S21 and the skipping score S22 are calculated separately, and the selection character string SS is selected comprehensively, so that problems of both overlapping reading and skipping can also be improved.

In addition, according to the above-described embodiment, the second score calculation unit 130 calculates the skipping score S22 by using the character-likeliness map CLM. The character-likeliness map CLM indicates the likelihood that some character C exists in the region of the input image IM. According to the present embodiment, skipping can be easily prevented.

### Second Embodiment

An example of a character recognition device 10A according to a second embodiment will be described with reference to FIGS. 11 to 13. The character recognition device 10A according to the second embodiment performs character recognition on the character string S included in the input image IM using a beam search algorithm. Here, in a case where candidate characters C are calculated for each of the plurality of characters C included in the character string S, and the candidate combination of each character C is set as the candidate character string CS, there is a problem in that as the amount of characters C included in the character string S becomes large, the number of candidate character strings CS increases. When the number of candidate character strings CS increases, it takes time and resources to select the selection character string SS. Consequently, an object of the present embodiment is to perform character recognition with less time and resources by using a beam search algorithm.

FIG. 11 is a diagram illustrating a beam search according to the second embodiment. The beam search according to the second embodiment will be described with reference to the drawing. In the present embodiment, the character recognition device 10A divides the input image IM into a plurality of partial input images IMP and performs character recognition. In an example shown in the drawing, the input image IM is divided into a partial input image IMP-1, a partial input image IMP-2, and a partial input image IMP-3. The partial input image IMP may be divided, for example, in accordance with a predetermined number of pixels. The predetermined number of pixels may be determined in accordance with a width at which the character C will be written.

Specifically, the character recognition device 10A first selects one or more selection character strings SS for the partial input image IMP-1 in the input image IM. Next, the character recognition device 10A selects one or more selection character strings SS for the partial input image IMP-1 and the partial input image IMP-2. In this case, since one or more selection character strings SS have already been selected for the partial input image IMP-1, the number of candidate character strings CS for the partial input image IMP-1 and the partial input image IMP-2 is reduced. Further, the character recognition device 10A selects a final selection character string SS for the partial input image IMP-1, the partial input image IMP-2, and the partial input image IMP-3. In this case, since one or more selection character strings SS have already been selected for the partial input image IMP-1 and the partial input image IMP-2, the number of candidate character strings CS for the partial input image IMP-1, the partial input image IMP-2, and the partial input image IMP-3 is reduced. In this way, in the present embodiment, the overall processing time is shortened by narrowing down the candidate character strings S for each partial input image IMP.

FIG. 12 is a diagram illustrating a consistency score for each partial input image in the beam search according to the second embodiment. The consistency score for each partial input image IMP in a case where “ [symbol] ” is written in the input image IM will be described with reference to the drawing. FIG. 12(A) shows the correspondence relation between the candidate character string CS and the consistency score in a case where the character recognition device 10A performs character recognition on the partial input image IMP-1, and FIG. 12(B) shows the correspondence relation between the candidate character string CS and the consistency score in a case where the character recognition device 10A performs character recognition on the partial input image IMP-1 and the partial input image IMP-2. Here, the consistency score is a score used when the selection unit 140 selects the selection character string SS, and is, for example, a score obtained by multiplying the first score S1 and the second score S2.

In FIG. 12(A), the character recognition device 10A calculates “ [symbol] ” as a candidate character string CS-11, “ [symbol] 1” as a candidate character string CS-12, and “ [symbol] ” as a candidate character string CS-13. The consistency scores of the candidate character strings CS are “1.0,” “0.3,” and “1.0.” The character recognition device 10A selects the candidate character string CS-11 which is a plausible character string and the candidate character string CS-13 as the selection character strings SS. In other words, the character recognition device 10A excludes a candidate character string C-12 from the candidates.

In FIG. 12(B), the character recognition device 10A calculates “ [symbol] ” as a candidate character string CS-21, “ [symbol] ” as a candidate character string CS-22, “ [symbol] ” as a candidate character string CS-23, “ [symbol] ” as a candidate character string CS-24, “ [symbol] [symbol] ” as a candidate character string CS-25, and “ [symbol] ” as a candidate character string CS-26. The consistency scores of the candidate character strings CS are “0.1,” “1.0,” “0.1,” “1.0,” “1.0,” and “1.0.” The character recognition device 10A selects the candidate character string CS-22, the candidate character string CS-24, the candidate character string CS-25, and the candidate character string CS-26 which are plausible character strings as the selection character strings SS. In other words, the character recognition device 10A excludes the candidate character string C-21 and the candidate character string CS-23 from the candidates. Here, in the examination of the partial input image IMP-1, “ [symbol] 1” which is the candidate character string CS-12 is excluded from the candidates, and thus in the examination of the partial input image IMP-1 and the partial input image IMP-2, the number of candidate character strings S can be reduced.

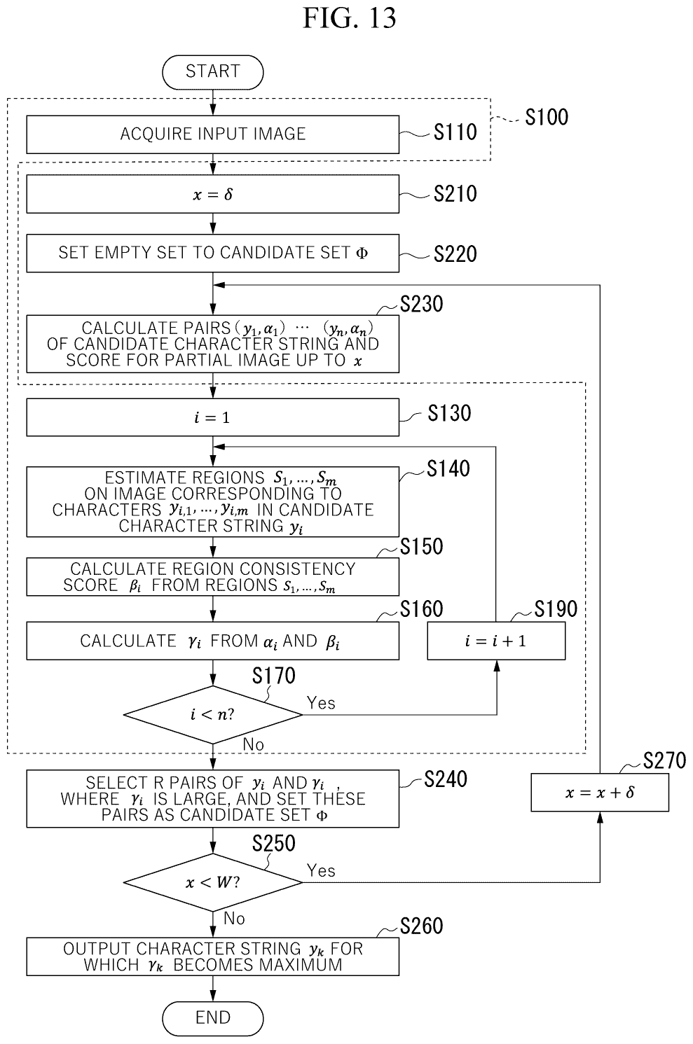

FIG. 13 is a flowchart illustrating a series of operations of a character recognition system according to the second embodiment. A series of operations of the character recognition system 1A according to the second embodiment will be described with reference to the drawing. Step S100 is the same as the operation of the character recognition system according to the first embodiment described in FIG. 5, and thus a description thereof will be omitted.

(Step S210) The character recognition device 10A sets x to δ. Here, δ is a predetermined integer indicating the range of the partial input image IMP. In addition, x indicates a range in which the character recognition device 10A recognizes characters. In this flowchart, the character recognition device 10A first calculates the candidate character string CS for a range from 0 to x. Here, x that is a range in which the character recognition device 10A recognizes characters is equivalent to the partial input image IMP in an example described with reference to FIG. 11.

(Step S220) The character recognition device 10A sets an empty set to a candidate set Φ.

(Step S230) The first score calculation unit 110 included in the character recognition device 10A calculates the first score S1 for each of the candidate character strings CS among the plurality of candidate character strings CS included in the partial input image IMP. That is, in a case where the candidate character string CS is yₙ and the first score S1 is an, the first score calculation unit 110 calculates (y₁, α₁) . . . (yₙ, αₙ).

(Step S240) The character recognition device 10A selects the selection character string SS in the partial input image IMP. Specifically, the character recognition device 10A selects R pairs of yᵢ and γᵢ, where γᵢ is large, and sets these pairs as the candidate set Φ. R is the number of character strings to be candidates in a case where character recognition is performed on the next partial input image IMP. If R is made to be small, the processing time can be shortened, but if it is too small, the possibility of erroneous recognition may increase.

(Step S250) The character recognition device 10A determines whether character recognition has been performed on all of the input images IM. Specifically, in a case where x is smaller than W, the character recognition device 10A advances the process to step S270. In a case where x is not smaller than W, the character recognition device 10A advances the process to step S260.

(Step S270) The character recognition device 10A extends the range in which character recognition is performed. Specifically, the character recognition device 10A sets the value obtained by adding δ to x as x, and advances the process to step S230.

(Step S260) The character recognition device 10A outputs the character string yₖ for which γₖ becomes maximum as the selection character string SS.

### Summary of Second Embodiment

According to the above-described embodiment, the first score calculation unit 110 included in the character recognition device 10A calculates the first score S1 for the partial input image IMP which is a portion of the input image IM. In other words, the first score calculation unit 110 calculates the first score S1 for the candidate character string CS which is a candidate for the character string S including some characters among a plurality of characters C that constitute the character string S included in the input image IM. In addition, the second score calculation unit 130 included in the character recognition device 10A calculates the second score S2 for the partial input image IMP which is a portion of the input image IM. In other words, the second score calculation unit 130 calculates the second score S2 for the candidate character string CS which is a candidate for the character string S including some characters among a plurality of characters C that constitute the character string S included in the input image IM. Since the character recognition device 10A calculates the candidate character string CS for each portion of the input image IM, it is possible to reduce the number of candidates for the entire character string included in the input image IM. Thus, according to the present embodiment, it is possible to perform character recognition with less time and resources by using a beam search algorithm.

### Third Embodiment

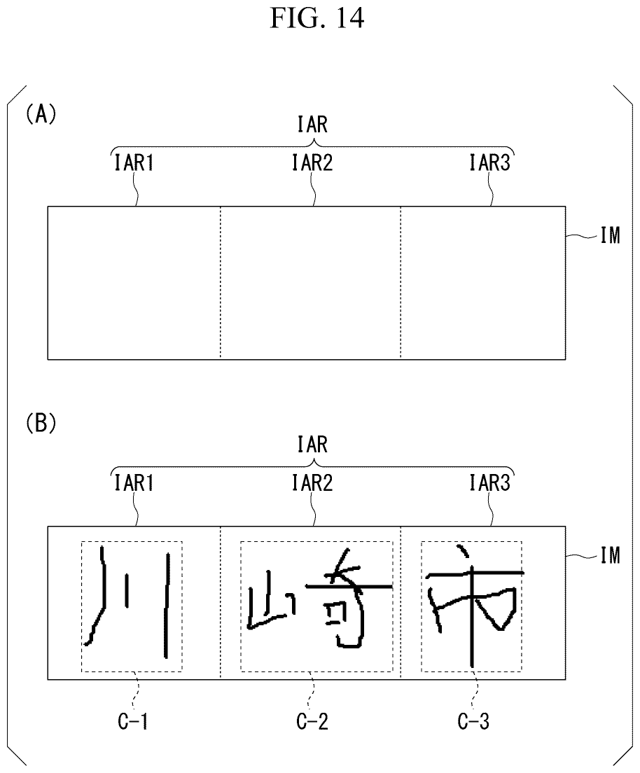

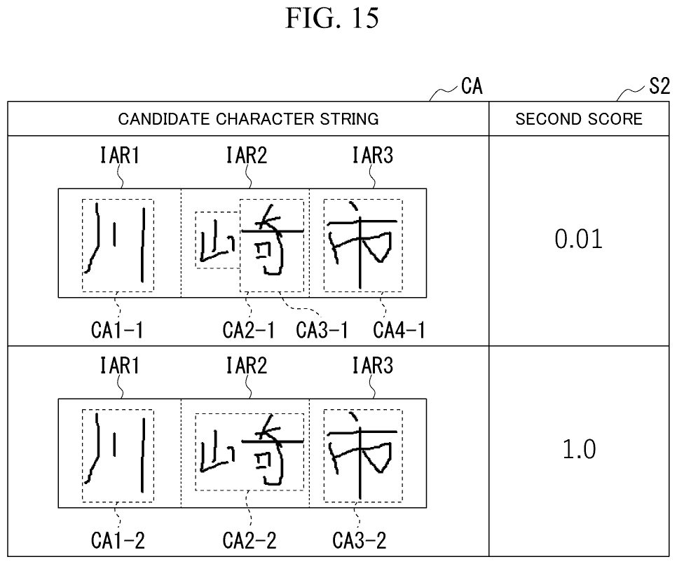

An example of a character recognition device 10B according to a third embodiment will be described with reference to FIGS. 14 and 15. The third embodiment differs from the other embodiments in that the spacing of reference characters or the region of characters to be written is determined in the input image IM. In the present embodiment, an object is to more correctly recognize the characters C included in the input image IM by performing character recognition on the basis of the spacing of reference characters or the region of characters to be written.

FIG. 14 is a diagram illustrating an example of an input image IM according to a third embodiment. The spacing of reference characters or the region of characters to be written, which is determined in the input image IM, will be described with reference to the drawing. FIG. 14(A) is an example of the input image IM in the present embodiment. FIG. 14(B) is an example of a case in which characters are written in the input image IM in the present embodiment.

The input image IM shown in FIG. 14(A) includes a plurality of character input regions IAR. Specifically, the input image IM includes a character input region IAR1, a character input region IAR2, and a character input region IAR3. The character input region IAR is given, for example, to a user who writes the character string S in the input image IM as a reference when characters are written. That is, the character input region IAR determines the spacing of reference characters or the region of characters to be written. In the following description, the character input region IAR may be referred to as a “frame.”

The character C is written in the input image IM shown in FIG. 14(B). Specifically, a character C-1 is written in the character input region IAR1, a character C-2 is written in the character input region IAR2, and a character C-3 is written in the character input region IAR3. The character C-1 is “ [symbol] ,” the character C-2 is “ [symbol] ,” and the character C-3 is “ [symbol] .”

FIG. 15 is a diagram illustrating an example of a second score according to the third embodiment. The second score S2 calculated by the second score calculation unit 130 will be described with reference to the drawing. In an example shown in the drawing, the candidate character string calculation unit 22 calculates the candidate character string CS of “ [symbol] ” and “ [symbol] .”

In a case where the candidate character string CS is “ [symbol] ,” the character region CA1-1 is included in the character input region IAR1, the character region CA2-1 and the character region CA3-1 are included in the character input region IAR2, and a character region CA4-1 is included in the character input region IAR3. In this case, since the character region CA2-1 and the character region CA3-1 are included in the character input region IAR2, two character regions CA exist in one frame (character input region IAR). In this case, in a case where a plurality of character regions CA exist in one frame, the second score calculation unit 130 calculates a consistency score P_{BOX} on the basis of the following Expression (4) with the amount of overlapping between the smaller character region CA and the frame region as m(y).

$$\begin{matrix}[ Equation 4 ] & \\ {P}_{BOX} ( y ) := {( {C}_{BP} )}^{m ( y )} & ( 4 )\end{matrix}$$

Here, C_{BP} is a constant between 0 and 1, and as this value decreases, the consistency score P_{BOX} becomes small. The value of C_{BP} may be obtained experimentally.

Here, an example of a case in which the selection unit 140 further selects the selection character string SS on the basis of the consistency score P_{BOX} will be described. In this case, the selection unit 140 selects the selection character string SS on the basis of the following Expression (5).

$$\begin{matrix}[ Equation 5 ] & \\ \hat{y} = arg {max}_{y} {P}_{OCR} ( y ) {P}_{LM} ( y ) {P}_{ovlp} ( y ) {P}_{skip} ( y ) {P}_{BOX} ( y ) & ( 5 )\end{matrix}$$

That is, in the present embodiment, the second score calculation unit 130 calculates the second score S2 on the basis of the character region CA which is a region corresponding to each character C included in the candidate character string CS and the character input region IAR.

### Summary of Third Embodiment

According to the above-described embodiment, the character recognition device 10B includes the second score calculation unit 130 to calculate the second score S2 on the basis of the character region CA and the character input region IAR. For example, in a case where a plurality of characters are included in one frame, the second score calculation unit 130 calculates a low value for the second score S2. The second score calculation unit 130 calculates a low value for the second score S2 in a case where a plurality of characters are included in one frame, which makes it possible to prevent erroneous recognition such as recognizing characters by dividing them into left-hand sides, radicals, and the like of kanji. Therefore, according to the present embodiment, the character C included in the input image IM can be recognized more correctly.

### Fourth Embodiment

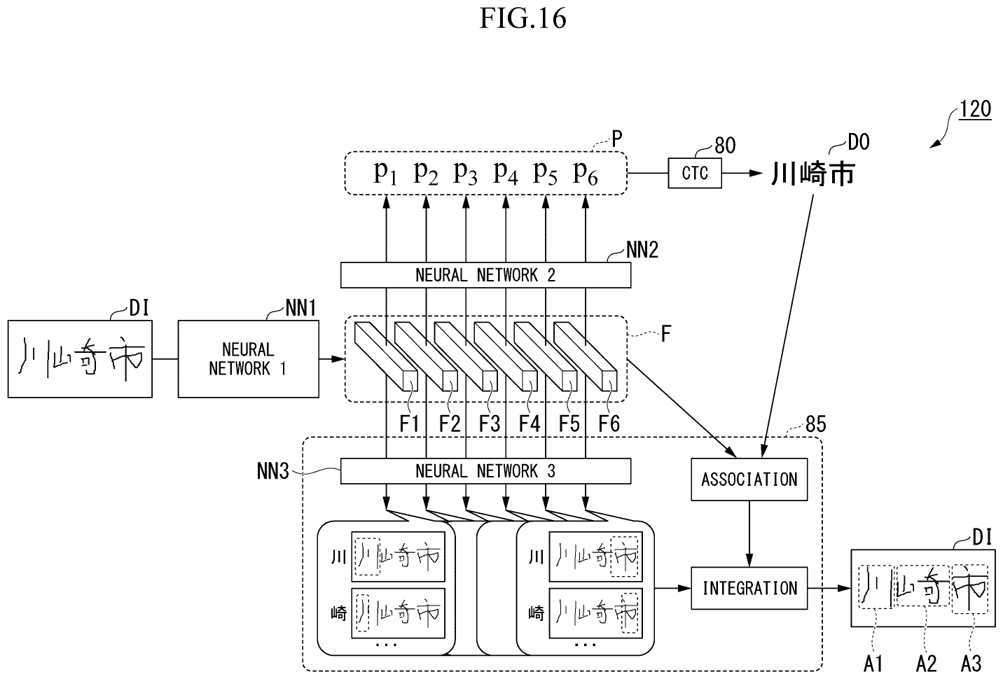

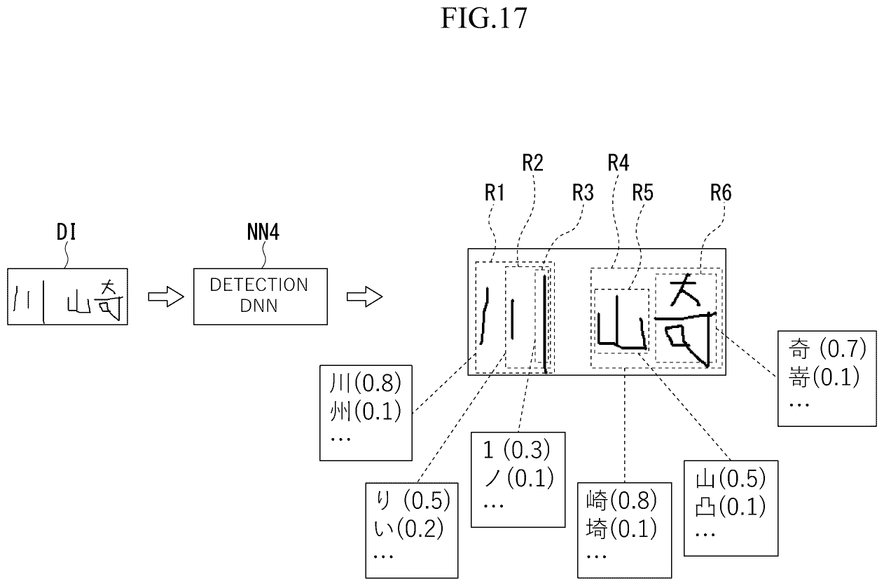

A fourth embodiment will be described with reference to FIGS. 16 and 17. In the fourth embodiment, a specific example of the character region estimation unit 120 will be described. An example of the character region estimation unit 120 will be described with reference to FIG. 16, and a modification example of the character region estimation unit 120 will be described with reference to FIG. 17.

FIG. 16 is a diagram illustrating an example of an operation of a character region estimation unit according to a fourth embodiment. An example of the character region estimation unit 120 will be described with reference to the drawing. First, input data DI is input to a neural network NN1. In this example, an example of a case in which the input data DI is an image of a character string will be described. Specifically, an example of a case in which the input data DI is an image of a character string in which “ [symbol] ” is handwritten horizontally from left to right will be described.

The neural network NN1 calculates a series of feature amounts F of an input character string. In a case where the input data DI is an image of a character string handwritten horizontally from left to right, the neural network NN1 recognizes a series of feature amounts F from left to right by the width of the determination range. In this example, the neural network NN1 calculates feature amounts from a feature amount F1 to a feature amount F6. Here, the neural network NN1 calculates the feature amount F in a number corresponding to the length of the rows of the input data DI.

A neural network NN2 calculates a probability distribution P for each feature amount F calculated by the neural network NN1. In this example, the neural network NN1 calculates feature amounts from the feature amount F1 to the feature amount F6, and thus the neural network NN2 calculates a probability distribution P1 corresponding to the feature amount F1 to a probability distribution P6 corresponding to the feature amount F6.

A connectionist temporal classification (CTC) 80 integrates each of the calculated probability distributions, calculates the probability distribution P of a character string corresponding to the input data DI, and outputs a character string recognized from the calculated probability distribution P as output data DO.

An estimation unit 85 acquires the feature amount F calculated by the neural network NN1. The estimation unit 85 estimates a range in which an element to be assigned a predetermined label can exist from the acquired feature amount F using a neural network NN3.

The estimation unit 85 associates each label of the output data DO recognized by the CTC 80 with each of the feature amounts F. In a case where one label in a sequence of labels of the output data DO is associated with a plurality of feature amounts F, the estimation unit 85 integrates and outputs the range estimated from the plurality of feature amounts F associated with the one label. The output result output by the estimation unit 85 specifies the range of each label in the input data DI. In an example shown in the drawing, a range A1 specifies the range of “ [symbol] ,” a range A2 specifies the range of “ [symbol] ,” and a range A3 specifies the range of “ [symbol] .”

FIG. 17 is a diagram illustrating a modification example of an operation of the character region estimation unit according to the fourth embodiment. The modification example of the operation of the character region estimation unit 120 will be described with reference to the drawing. In the modification example of the operation of the character region estimation unit 120, object detection is applied to estimate a character region.

First, the input data DI is input to a neural network NN4. In this example, an example of a case in which the input data DI is an image of a character string will be described. Specifically, an example of a case where the input data DI is an image of a character string in which “ [symbol] ” is handwritten horizontally from left to right will be described. The neural network NN4 is a detection deep neural network (DNN). The neural network NN4 receives an image as an input and outputs a plurality of candidate rectangles R and the score of a character corresponding to each of the candidate rectangles R.

Specifically, the neural network NN4 outputs a candidate rectangle R1, a candidate rectangle R2, a candidate rectangle R3, a candidate rectangle R4, a candidate rectangle R5, a candidate rectangle R6, and the score of a character corresponding to each of the candidate rectangles R. More specifically, the neural network outputs a score of “0.8” for the character “ [symbol] ” and a score of “0.1” for the character “ [symbol] ” corresponding to the candidate rectangle R1, a score of “0.5” for the character “ [symbol] ” and a score of “0.2” for the character “ [symbol] ” corresponding to the candidate rectangle R2, a score of “0.3” for the character “1” and a score of “0.1” for the character “ [symbol] ” corresponding to the candidate rectangle R3, a score of “0.8” for the character “ [symbol] ” and a score of “0.1” for the character “ [symbol] ” corresponding to the candidate rectangle R4, a score of “0.5” for the character “ [symbol] ” and a score of “0.1” for the character “ [symbol] ” corresponding to the candidate rectangle R5, and a score of “0.7” for the character “ [symbol] ” and a score of “0.1” for the character “ [symbol] ” corresponding to the candidate rectangle R6.

### Summary of Fourth Embodiment

According to the above-described embodiment, the character region estimation unit 120 includes the estimation unit 85 to estimate a region in which a character C can exist on the basis of the feature amount F acquired from the input data DI, associate the character C with at least one of the plurality of feature amounts F, and specify the region corresponding to each character C by integrating a plurality of ranges associated with one label. By using the present embodiment, it is possible to perform an efficient search using a beam search algorithm. In addition, the estimation of a character region according to the present embodiment can be easily implemented.

In addition, according to the above-described embodiment, the character region estimation unit 120 receives an image as an input and outputs a plurality of candidate rectangles R and the score of a character corresponding to each of the candidate rectangles R. By using the present embodiment, it is possible to estimate a character region with fewer resources.

### Fifth Embodiment

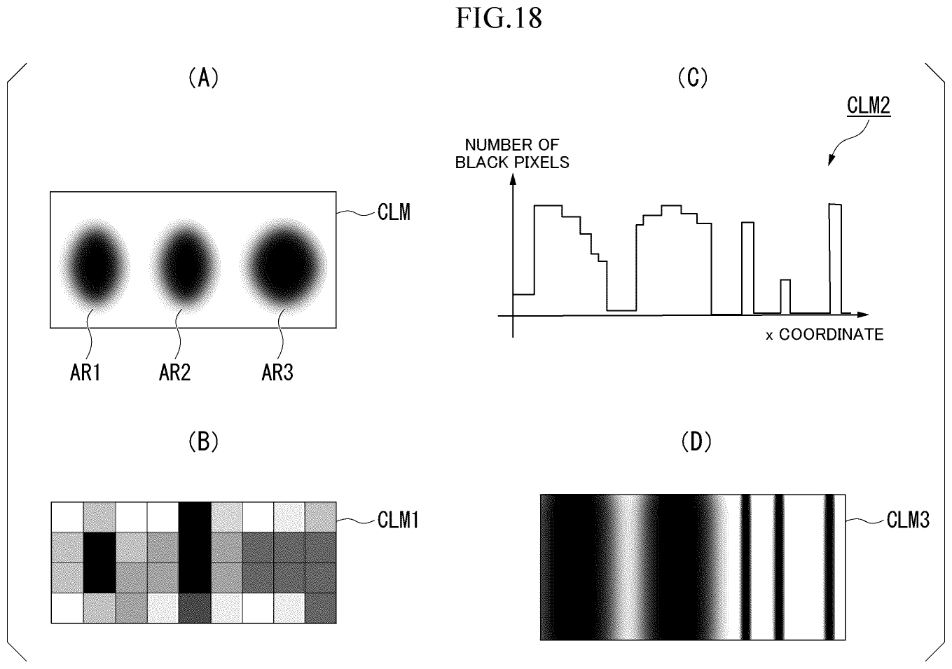

A fifth embodiment will be described with reference to FIGS. 18 to 20. In the fifth embodiment, a modification example of the character-likeliness map CLM generated by the character-likeliness map generation unit 1321 will be described. FIG. 18 is a diagram illustrating a modification example of a character-likeliness map according to the fifth embodiment. FIG. 18(A) is the character-likeliness map CLM described in the first embodiment.

FIG. 18(B) is a character-likeliness map CLM1 which is a first modification example of the character-likeliness map CLM according to the fifth embodiment. The character-likeliness map CLM1 differs from the character-likeliness map CLM in that character likeliness expressed in gradation for each region constituted by a plurality of pixels. In this way, the character-likeliness map CLM1 may have character likeliness calculated for each predetermined range in the input image IM.

FIG. 18(C) is a character-likeliness map CLM2 which is a second modification example of the character-likeliness map CLM according to the fifth embodiment. The character-likeliness map CLM2 includes a correspondence relation between the x coordinate of the input image IM and the number of black pixels at each x coordinate. That is, the character-likeliness map CLM2 may be a luminance histogram. In the present embodiment, since the input image IM contains characters written horizontally, the X coordinate which is a direction in which the characters are written is used. In a case where the input image IM contains characters written vertically, the Y coordinate may be used. Since the character-likeliness map CLM2 uses information on the number of black pixels at each X coordinate, it is possible to easily create the character-likeliness map CLM2.

FIG. 18(D) is a character-likeliness map CLM3 which is a third modification example of the character-likeliness map CLM according to the fifth embodiment. The character-likeliness map CLM3 is obtained by normalizing the character-likeliness map CLM2 so as to take a value from 0 to 1.

Alternatively, the character-likeliness map CLM is obtained by dividing the input image IM into small regions having a grid shape, and may be based on the total number of black pixels for each small region.

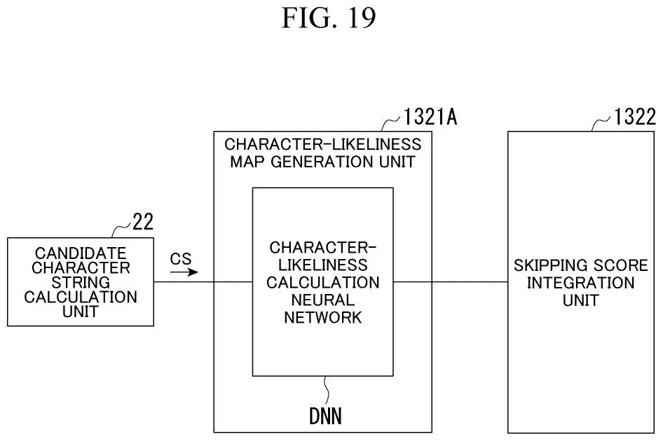

FIG. 19 is a diagram illustrating an example of a functional configuration of a modification example of a character-likeliness map generation unit according to the fifth embodiment. A character-likeliness map generation unit 1321A which is a modification example of the character-likeliness map generation unit 1321 will be described with reference to the drawing. The character-likeliness map generation unit 1321A differs from the character-likeliness map generation unit 1321 in that it includes a character-likeliness calculation neural network DNN.

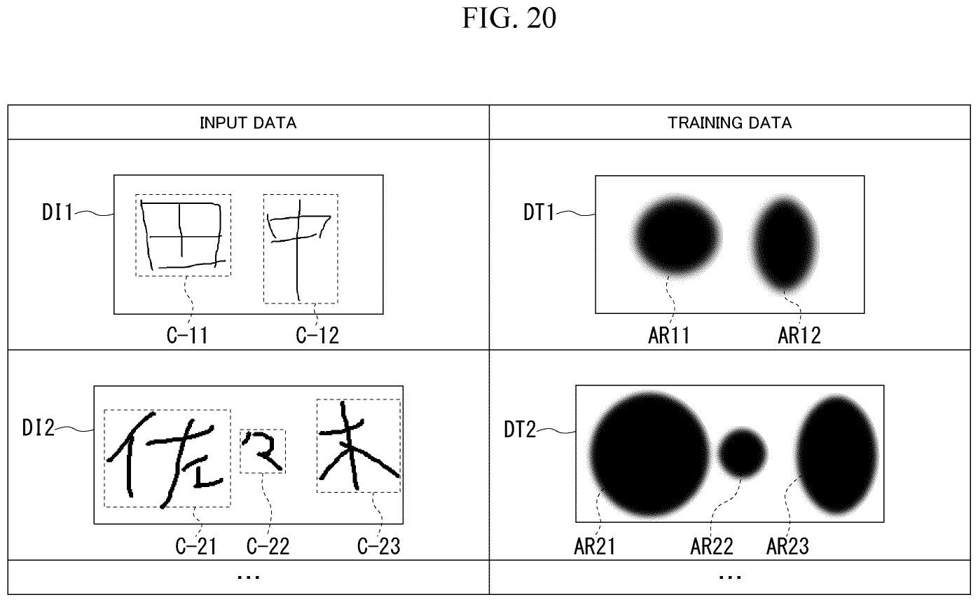

The character-likeliness calculation neural network DNN is a neural network that has been trained in advance so as to predict character likeliness. FIG. 20 is a diagram illustrating an example of input data DI and training data DT according to the fifth embodiment. An example of the input data DI and an example of the training data DT will be described with reference to the drawing.

In an example shown in FIG. 20, input data DI1 corresponds to training data DT1, and input data DI2 corresponds to training data DT2. The input data DI1 includes a character C-11 and a character C-12, and the training data DT1 includes a region AR11 corresponding to the character C-11 and a region AR12 corresponding to the character C-12. The input data DI2 includes a character C-21, a character C-22, and a character C-23, and the training data DT2 includes a region AR21 corresponding to the character C-21, a region AR22 corresponding to the character C-22, and a region AR23 corresponding to the character C-23.

### Summary of Fifth Embodiment

According to the above-described embodiment, the character-likeliness map generation unit 1321 can easily generate the character-likeliness map CLM by using the character-likeliness map CLM1, the character-likeliness map CLM2, or the character-likeliness map CLM3.

In addition, according to the above-described embodiment, the character-likeliness map generation unit 1321 includes the character-likeliness calculation neural network DNN, and can therefore generate the character-likeliness map CLM through machine learning. According to the above-described embodiment, the use of machine learning makes it possible to be resistant to noise and to prevent erroneous recognition. In addition, according to the above-described embodiment, the use of machine learning also makes it possible to correctly recognize the input image IM with a different background.

As described above, in the embodiment, a plurality of modification examples have been described. Here, a plurality of embodiments and a plurality of modification examples may be combined and implemented insofar as it is possible to combine them.

Meanwhile, the functions of the information processing device in the above-described embodiments may be realized by a computer. In that case, these functions may be realized by a program for realizing the functions being recorded in a computer readable recording medium, and the program recorded in this recording medium being read into a computer system and executed. Meanwhile, the term “computer system” referred to here is assumed to include an OS and hardware such as peripheral devices. In addition, the term “computer readable recording medium” refers to a flexible disk, a magneto-optic disc, a ROM, a CD-ROM, a DVD-ROM, a portable medium such as a USB memory, and a storage device such as a hard disk built into a computer system. Further, the “computer readable recording medium” is assumed to include recording mediums that dynamically hold a program during a short period of time like networks such as the Internet or communication lines when a program is transmitted through communication lines such as a telephone line, and recording mediums that hold a program for a certain period of time like a volatile memory inside a computer system serving as a server or a client in that case. In addition, the above-mentioned program may be a program which is used for realizing a portion of the aforementioned functions, and may be a program which is capable of realizing the aforementioned functions by a combination of programs previously recorded in the computer system.

According to at least one of the embodiments described above, a first score calculation unit, a character region estimation unit, a second score calculation unit, and a selection unit are included, and thus it is possible to correctly recognize characters included in an input image.

While several embodiments of the present invention have been described, these embodiments have been presented by way of example only, and are not intended to limit the scope of the invention. Indeed, these embodiments described herein may be embodied in a variety of other forms, and furthermore, various omissions, substitutions and changes in the form of the embodiments described herein may be made without departing from the spirit of the present invention. The appended claims and their equivalents are intended to cover such forms or modifications as would fall within the scope and spirit of the present invention.

### REFERENCE SIGNS LIST

1 Character recognition system
10 Character recognition device
21 Input image acquisition unit
22 Candidate character string calculation unit
23 Output unit
24 Input rule information storage unit
110 First score calculation unit
120 Character region estimation unit
130 Second score calculation unit
140 Selection unit
111 Character recognition score calculation unit
112 Knowledge processing score calculation unit
113 First score integration unit
131 Overlapping reading score calculation unit
132 Skipping score calculation unit
133 Second score integration unit
1321 Character-likeliness map generation unit
1322 Skipping score integration unit
IM Input image
S Character string
C Character
CS Candidate character string
CA Character region
S1 First score
S2 Second score
S11 Character recognition score
S12 Knowledge processing score
S21 Overlapping reading score
S22 Skipping score
SS Selected character string
IR Input rule
IAR Character input region
CLM Character-likeliness map
MSK Mask
IMP Partial input image

1. A character recognition device comprising:
a first score calculation unit that calculates a first score indicating a likelihood of a character string, or the first score for each of a plurality of candidate character strings which are candidates for character strings included in an input image;
a character region estimation unit that estimates a region corresponding to each character included in the candidate character string among regions of the input image;
a second score calculation unit that calculates a second score indicating a consistency of characters included in the candidate character string on the basis of the region estimated by the character region estimation unit; and
a selection unit that selects one or more character strings from among the plurality of candidate character strings on the basis of the calculated first score and the calculated second score.

2. The character recognition device according to claim 1, wherein the first score calculation unit calculates the first score of the candidate character string included in a partial input image which is a part of the input image.

3. The character recognition device according to claim 1, wherein the second score calculation unit calculates the second score on the basis of an amount by which regions corresponding to the characters included in the candidate character string overlap each other.

4. The character recognition device according to any one of claim 1, wherein the second score calculation unit calculates the second score on the basis of the characters included in the candidate character string and the region estimated by the character region estimation unit.

5. The character recognition device according to claim 4, wherein the second score calculation unit calculates the second score on the basis of a likelihood that some character exists in the region of the input image.

6. The character recognition device according to any one of claim 1, wherein the input image includes a plurality of character input regions, and
the second score calculation unit calculates the second score on the basis of the region corresponding to each character included in the candidate character string and the character input regions.

7. A character recognition method comprising:
a first score calculation step of calculating a first score indicating a likelihood of a character string, or the first score for each of a plurality of candidate character strings which are candidates for character strings included in an input image;
a character region estimation step of estimating a region corresponding to each character included in the candidate character string among regions of the input image;
a second score calculation step of calculating a second score indicating a consistency of characters included in the candidate character string on the basis of the estimated region; and
a selection step of selecting one or more character strings from among the plurality of candidate character strings on the basis of the calculated first score and the calculated second score.

8. A program causing a computer to execute:
a first score calculation step of calculating a first score indicating a likelihood of a character string, or the first score for each of a plurality of candidate character strings which are candidates for character strings included in an input image;
a character region estimation step of estimating a region corresponding to each character included in the candidate character string among regions of the input image;
a second score calculation step of calculating a second score indicating a consistency of characters included in the candidate character string on the basis of the estimated region; and
a selection step of selecting one or more character strings from among the plurality of candidate character strings on the basis of the calculated first score and the calculated second score.
